(19) United States
(12) Patent Application Publication
(10) Pub. No.: US 2025/0167633 A1
(43) Pub. Date: May 22, 2025

(54) ELECTRIC MOTOR

(71) Applicant: MAHLE International GmbH, Stuttgart (DE)

(72) Inventor: Peter Sever, Murska Sobota (SI)

(21) Appl. No.: 18/689,424

(22) PCT Filed: Aug. 31, 2022
(86) PCT No.: PCT/EP2022/074214

§ 371 Date: Jul. 31, 2024

(30) Foreign Application Priority Data
Sep. 6, 2021 (DE) 102021209821.5

(51) Int. Cl. H02K 9/193; H02K 1/20; H02K 7/00

(52) U.S. Cl. CPC H02K 9/193; H02K 1/20; H02K 7/003

(57) ABSTRACT

An electric motor is disclosed. The electric motor includes a sheath for forming a main cavity, into which a coolant for cooling components of the electric motor is introduced. A stator is provided including a first stator end winding and a second stator end winding and a rotor. An impeller pumps coolant into a region of the first and second stator end windings. A dividing wall delimits a first coolant circulation chamber and/or a second coolant circulation chamber into zones that include an impeller inlet zone, an impeller air gap zone, an impeller outlet zone, an injection zone. The dividing wall is an independent component that includes a plurality of spacers for providing the zones.

The present invention relates to a wet rotor-type of electric motors for the traction drive of an electric vehicle, wherein the electric motor is cooled directly by means of a dielectric coolant, in particular by means of an oil, wherein at least one rotor and at least one section of the windings are subjected to the coolant, which is driven by the rotor of the electric motor.

EP 3 507 889 A1 discloses a rotor for the direct cooling utilization, wherein a cast filling body is used to drive a flow of the coolant in a direction of the head of the windings, where the oil is released from the rotor through the plurality of radial bores and/or radial passages on both sides of the rotor, which are formed by the filling body and a shaft journal.

In the case of the known solutions, the drive power for a coolant flow utilization, which is created by means of the cast filling body, is poor because the flow, which is created by means of the filling body, is constantly interrupted by the coolant particles, which circulate again in an unregulated manner.

It is thus the object of the invention to provide an improved or at least alternative embodiment for the coolant flow utilization, in which described disadvantages are overcome.

This object is solved according to the invention by means of the subject matter of independent claim 1. Advantageous embodiments are the subject matter of the dependent claims.

According to a subject matter of the present invention, a dividing wall is used, preferably as an independent component, which is fastened to an end plate of an electric motor sheath in the region of a recirculation chamber, wherein an impeller on a rotor of an electric motor is used in a function of a pump to drive a coolant through the cooling system of the electric motor, and to thus use the dividing wall element in the region of the circulation chamber to utilize a regulated behavior of the coolant flow.

By cooling a stator and the windings of the electric motor with the impeller in a combination with the dividing wall, a cooling performance and thus a continuous performance of the electric motor is increased significantly in an advantageous manner.

In the present invention, the compound terms “first” and/or “second” are used to simplify the description. In the context of the present invention, the individual terms “first” and “second” of the compound term “first/second” are always connected with an “and/or”. The “first” and/or the “second” element can thus be present in the rotor. In this case, the respective “first” element is connected exclusively to a further “first” element of the rotor or the first axial end of the rotor, and the respective “second” element is connected exclusively to a further “second” element of the rotor or the second axial end of the rotor. Where the individual terms “first” and “second” are not used in the compound term “first/second”, they are to be understood according to this use. The terms “axial” and “radial” furthermore always refer to the axis of rotation.

In an advantageous embodiment, a rotor of an electric motor comprises a hollow shaft and a rotor core. The hollow shaft is a two-piece hollow structure, which comprises a hollow shaft core and a corresponding support body, adapted to be assembled, and adapted to receive the rotor core in its place. In an advantageous embodiment, the hollow shaft and the corresponding rotor core are a cylindrical body, which comprises a first end and a second end on the opposite side of the hollow shaft. In an advantageous embodiment, the hollow shaft comprises an inlet opening for introducing the coolant into the main cavity of the hollow shaft, wherein the hollow shaft comprises a plurality of channels for releasing the coolant from the hollow shaft into an inlet region of the impeller. The rotor core comprises a cylindrical body, wherein it further comprises a plurality of layered sheet metals made of electrical steel, wherein the rotor core comprises a first adjoining front surface on a first side of the rotor core and a second adjoining front surface on the second—opposite—side of the rotor core, wherein at least one side of the rotor core comprises a feature of the impeller. The rotor core further comprises the impeller with a plurality of blades, in order to support the flow of the coolant within a sheath of the electric motor. In an advantageous embodiment, the channels for releasing the coolant from the hollow shaft are located in the region close to the outer circumferential edge of the hollow shaft, more precisely, in the region of an interference fit connection between the hollow shaft core and the corresponding support body, wherein the number of the channels is preferably equal to the number of the blades on the impeller and wherein the position of the channels is aligned with a front edge of the corresponding blades.

In advantageous embodiments, the electric motor further comprises a sheath and a stator with a plurality of wires, in order to form windings. The stator is a cylindrical body, which comprises a layered stator core, wherein it further comprises a first end and a second end on the opposite side of the stator core. The winding further comprises a winding head on both sides of the stator core. An inner volume in the form of a main cavity of the electric motor is provided accordingly and is delimited by the sheath, the stator and the rotor. The main cavity of the electric motor comprises at least two sub-cavities for a coolant circulation, wherein a first coolant circulation chamber is a cavity, which is delimited by the sheath and the first side of the stator and the first side of the rotor, wherein it further comprises a first winding head. Similarly, a second coolant circulation chamber is a cavity, which is delimited by the sheath and the second side of the stator and the second side of the rotor, wherein it further comprises a second winding head.

In advantageous embodiments, the oil, which is introduced into the main cavity of the electric motor, circulates on the rotor with the help of the impeller, wherein the sheath further comprises a dividing wall for dividing the coolant circulation chamber into zones, which comprise an impeller inlet zone, an impeller air gap zone, an impeller outlet zone, an injection zone, wherein a remaining section of the coolant circulation chamber is considered to be the head circulation zone of the winding. The dividing wall comprises a first boundary surface, opposite the rotor, more precisely, the impeller, and a second boundary surface, opposite the sheath of the electric motor. For an improved hydraulic performance of the impeller, the air gap between the impeller and the sheath is decreased by the first boundary surface of the dividing wall, which consequently provides a gap zone, where a distance between the dividing wall and between the impeller is between 0.2 mm and 10 mm, wherein the impeller outlet zone provides the opening, through which the oil is released from the impeller into the remaining section of the coolant circulation chamber, and wherein the coolant circulation in the coolant circulation chamber is driven by the flow of the coolant, which comes from the impeller outlet zone. In an advantageous embodiment, the second boundary surface of the dividing wall comprises a plurality of spacers, by means of which the gap for providing the injection zone is created and is used to inject the coolant back into the region of the impeller inlet zone. Advantageously, the regulated circulation of the coolant flow in the circulation chamber of the electric motor is regulated, wherein hydraulic losses, which are created by the impeller, are decreased and the cooling performance of the cooling system is improved significantly.

In one embodiment, in particular an alternative embodiment, the dividing wall similarly comprises a central opening, wherein it further comprises a plurality of grooves and/or openings, through which the coolant is guided from the injection zone into the impeller inlet zone.

Further important features and advantages of the invention become obvious from the appended claims, from the drawings and from the accompanying figure description on the basis of the drawings.

It goes without saying that the above features and those, which are to be described below, cannot only be used in the combinations specified in each case, but likewise in other combination or alone, without deviating from the scope of the present invention.

A preferred embodiment of the invention is shown in the drawings and will be described in more detail in the following description, in which identical reference numerals refer to identical or similar or functionally identical components.

In each case schematically,

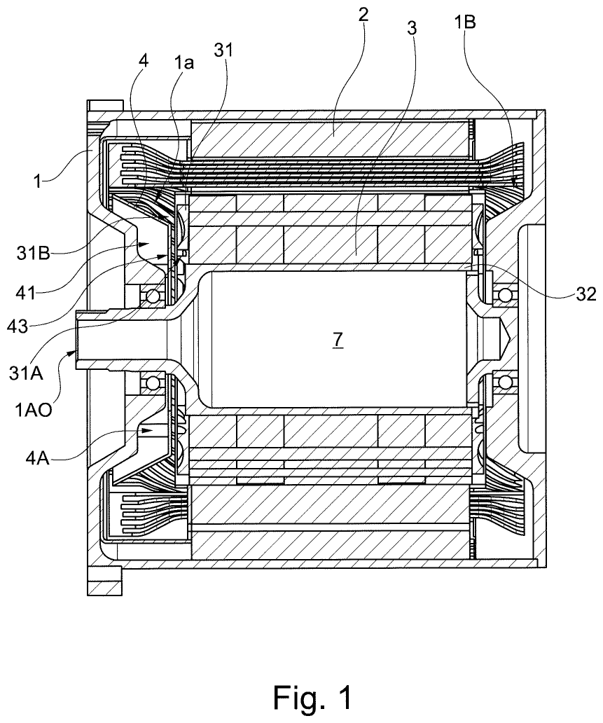

FIG. 1 shows a sectional view of an electric motor, which comprises a dividing wall according to the invention in an advantageous embodiment,

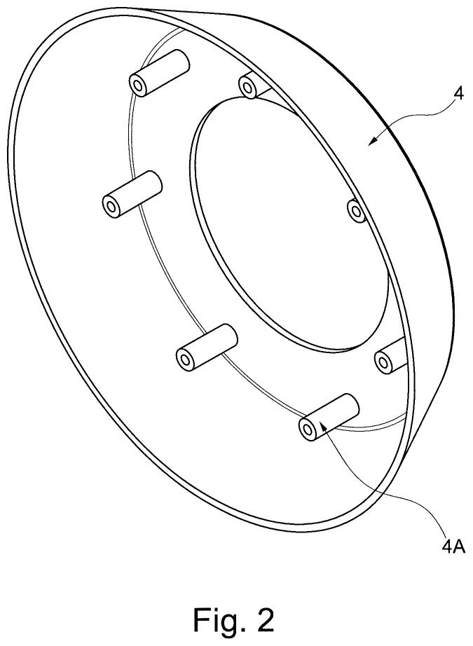

FIG. 2 shows an isometric view of a dividing wall according to the invention in the advantageous embodiment.

FIG. 1 shows a sectional view of an electric motor, which comprises a dividing wall 4 according to the invention in an advantageous embodiment. The electric motor comprises a sheath 1, a stator 2 and a rotor 3. The rotor 3 further comprises an impeller 31, wherein a first coolant circulation chamber 1A is in each case formed on a first side of the stator 2 and of the rotor 3, or a second coolant circulation chamber 1B is formed on a second side of the stator 2 and of the rotor 3, respectively. In the advantageous embodiment, the dividing wall 4 delimits the first coolant circulation chamber 1A into an impeller inlet zone 31A, an impeller air gap zone 41, an impeller outlet zone 31B, an injection zone 41, wherein a remaining section of the first coolant circulation chamber 1A is considered to be the head circulation zone of the winding.

FIG. 2 shows an isometric view of a dividing wall 4 according to the invention in the advantageous embodiment, wherein the dividing wall 4 comprises a plurality of spacers 4A, by means of which the gap for providing the injection zone 41 is created and is used to inject the coolant back into the region of the impeller inlet zone 43.

All parts of the electric motor, in particular the dividing wall 4, are shown and described within the description in the embodiment of the best mode. However, different shapes/sizes/distributions are likewise conceivable, wherein the coolant is preferably an oil, an air or a mixture of oil and air.

1. An electric motor, which comprises a sheath (1) for forming a main cavity of the electric motor, into which a coolant for cooling the components of the electric motor is introduced,
wherein the electric motor comprises a stator (2) with a first stator end winding and a second stator end winding and a rotor (3),
wherein the electric motor further comprises an impeller (31) for pumping the coolant into the region of the end windings.

2. The electric motor according to claim 1,
characterized in
that the main cavity of the electric motor comprises a first coolant circulation chamber (1A) in the region of the first stator end winding and a second coolant circulation chamber (1B) in the region of the second end winding.

3. The electric motor according to claim 2,
characterized in
that the electric motor further comprises a dividing wall (4) for delimiting the first coolant circulation chamber (1A) and/or the second coolant circulation chamber (1B) into zones, which comprise an impeller inlet zone (31A), an impeller air gap zone (41), an impeller outlet zone (31B), an injection zone (41).

4. The electric motor according to claim 3,
characterized in
that the remaining section of the first coolant circulation chamber (1A) and/or the remaining section of the second coolant circulation chamber (1B) is used to cool the electric motor by means of coolant circulation.

5. The electric motor according to claim 3 or 4,
characterized in
that the dividing wall (4) is an independent component, which comprises a plurality of spacers (4A) for providing the zones according to claim 1.

6. The electric motor according to one of claims 3 to 5,
characterized in
that the dividing wall (4) comprises a central opening and a plurality of grooves and/or openings, through which the coolant is guided from the injection zone into the impeller inlet zone.

7. The electric motor according to one of claims 1 to 6,
characterized in
that the rotor (3) comprises a hollow shaft (32) and a rotor core,
that the hollow shaft (32) is a two-piece hollow structure, which comprises a hollow shaft core and a corresponding support body,
adapted to be assembled, and adapted to receive the rotor core in its place.

8. The electric motor according to claim 7,
characterized in
that the hollow shaft (32) and the rotor core are a cylindrical body, which comprises a first end and a second end on opposite sides of the hollow shaft (32).

9. The electric motor according to claim 7 or 8,
characterized in
that the hollow shaft (32) comprises an inlet opening (1AO) for introducing the coolant into a main cavity (7) of the hollow shaft (32), wherein the hollow shaft (32) comprises a plurality of channels for releasing the coolant from the hollow shaft (32) into an inlet region of the impeller (31).
